(19) United States
(12) Patent Application Publication
(10) Pub. No.: US 2024/0401285 A1
(43) Pub. Date: Dec. 5, 2024

(54) INTERCONNECTING MAT SYSTEM

(71) Applicant: SNBC INC., Edmonton (CA)

(72) Inventors: Shawn BEAMISH, Edmonton (CA); Marlin BELANGER, Edmonton (CA)

(21) Appl. No.: 18/261,176

(22) PCT Filed: Dec. 10, 2021
(86) PCT No.: PCT/CA2021/051785

§ 371 Date: Jul. 12, 2023

Related U.S. Application Data
(60) Provisional application No. 63/139,678, filed on Jan. 20, 2021.

(51) Int. Cl. E01C 9/08; E01C 5/00

(52) U.S. Cl. CPC E01C 9/086; E01C 5/005; E01C 9/083

(57) ABSTRACT

A mat assembly having a plurality of mats, interconnected with connectors including a cable for passing through a channel of each mat, wherein each end of the cable is secured, and a ratchet or winch mechanism for shortening the effective length of the cable; such that, when shortened, the cable retains abutting mats in contact with each other; and/or 5 including a bridge connector having two or more expandable plugs, spaced apart on the connector, and each expandable plug fits within and expands to securely engage an opening in each of the abutting mats.

### FIELD OF THE INVENTION

The present invention relates to a system for interconnecting a plurality of mats.

### BACKGROUND OF THE INVENTION

In the oil and gas industry, ground cover mats or rig mats are used to temporarily support heavy equipment and transport trucks over wet or disturbed ground in remote locations. These mats tend to have a high weight per area and need to cover significant areas. Accordingly, the mats are provided in manageable sizes and weights, transported to remote locations, interlocked together for use, and thereafter disassembled.

There are many prior art configurations of rig mats. A conventional rig mat consists of planking contained within a steel perimeter frame formed from I-beams. The frame is typically welded together at the corners, where the I-beams abut each other at right angles. In other examples, the mats comprise fiber-reinforced plastic (FRP) panels which have a high strength-to-weight ratio. Mats are typically connected together with simple clamps or overlapping elements. The interconnections are typically not very robust.

There remains a need in the art for a mat or panel system with convenient and robust interconnections.

### SUMMARY OF THE INVENTION

In general terms, the invention comprises a modular system of interconnected mats or panels, where each mat or panel may comprise any flat structural element having two opposing major surfaces. The mat or panel may be monolithic or assembled from components, may have a closed or open major surface, and may be of any geometric shape.

The mats or panels may be assembled together and used for a wide variety of different purposes and the interconnected mats or panels may be configured to be suitable for its intended purpose. Without limiting the generality of the foregoing, the mats or panels may be used to form oilfield or rig matting, construction or worksite matting, temporary roads or driveways, temporary work floors or platforms, stages, walkways (with or without railings), bridges or docks built on a substructure, floating structures such as bridges or docks, temporary shelters or barriers, furniture such as bookshelves, cabinets, tables or dividers, shoring, spill containment or secondary containment structures, or trench barriers.

In one aspect, the invention may comprise an assembly of at least two mats or panels, which abut each along a first edge, and each mat or panel has a second edge which forms a corner at an intersection with the first edge, wherein each corner defines a channel between the first edge and the second edge, and the assembly comprises:
(a) a cable passing through the corner channel of each of abutting mat or panel, wherein each end of the cable is secured; and
(b) a ratchet or winch mechanism for shortening the effective length of the cable;
(c) wherein the cable, when shortened, retains the abutting mats or panels in contact with each other.

In some embodiments, the ratchet mechanism may comprise a ratcheting winch drum disposed in an opening in one mat or panel. The ratcheting drum may have a drive head or nut which can be turned by a wrench or socket. In one embodiment, this system is used to interconnect four mats in a four-corner junction.

In another aspect, each mat or panel corner defines an opening either in an edge surface and/or a major surface, and the system comprises a bridge connector having at least two expandable plugs, spaced apart on the connector, and each configured to fit within and expand to securely engage an opening.

In some embodiments, the expandable plug may comprise a compressible elastomer, which expands radially outwards when compressed axially. The expandable plugs preferably have a high coefficient of friction with the interior surface of the opening it engages, which helps secure the plug within the opening when actuated. The expandable plugs may be compressed by a cam operated by a lever, by a rotating cam actuator or by a nut and bolt configuration.

In some embodiments, the connector may have four expandable plugs, configured to connect four mats or panels together, in a four-corner junction. In this example, the connector comprises a flat connector body and four pots which insert into vertical openings in the mats, wherein the expandable plugs are disposed within the pots.

The various connectors described herein may be combined in different combinations to create two-dimensional arrays or three-dimensional structures formed with mats or panels described herein.

### BRIEF DESCRIPTION OF THE DRAWINGS

In the drawings shown in the attached drawing, like elements may be assigned like reference numerals. The drawings are not necessarily to scale, with the emphasis instead placed upon the principles of the present invention. Additionally, each of the embodiments depicted are but one of a number of possible arrangements utilizing the fundamental concepts of the present invention.

FIG. 1 shows a rectangular mat with corner openings.

FIG. 2A shows a corner in detail, with a vertical opening and two side openings.

FIG. 2B shows a vertical opening sleeve.

FIG. 3 shows the configuration of a four-corner junction, prior to cable insertion.

FIG. 4 shows the four-corner junction with a cable and cable tightening mechanism inserted.

FIG. 5A shows an expanding plug connector prior to insertion into side openings of two adjacent mats. FIG. 5B shows the same connector after insertion.

FIG. 6 shows a side view of an expanding plug connector, with cam levers.

FIG. 7 shows the connector of FIG. 6 in a compressed position, with the plugs expanded radially outward.

FIG. 8 shows a mat with four connectors installed as handles.

FIG. 9 shows an alternative embodiment of an expanding plug connector.

FIG. 10 shows a cross-sectional view of the connector of FIG. 9.

FIG. 11 shows an exploded view of the connector of FIG. 9.

FIG. 12 shows four mats interconnected with expanding plug connectors.

FIG. 13 shows a three-dimensional configuration of a plurality of panels assembled using connectors of the present invention.

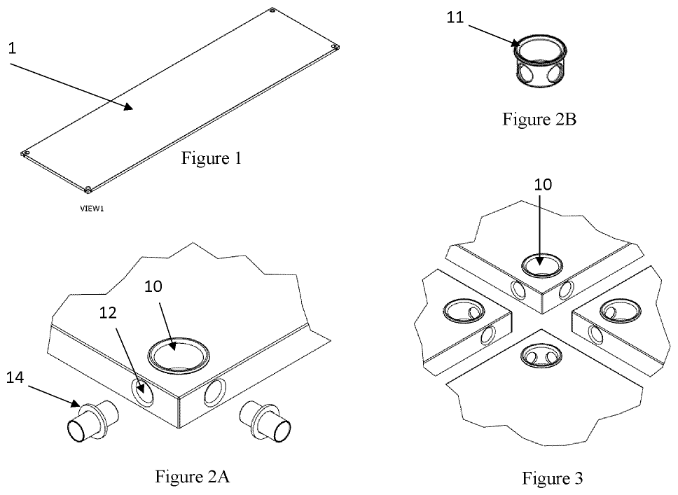

### DETAILED DESCRIPTION

Any term or expression not expressly defined herein shall have its commonly accepted definition understood by a person skilled in the art.

In one aspect, the invention comprises a modular system of interconnected mats or panels. For simplicity, the element will be referred to as a mat, but includes any flat structural element having two opposing major surfaces and also include panels, as that term is commonly understood. The terms “mat” and “panel” may be used interchangeably.

The mats may be interconnected together and used for a wide variety of different purposes and may be configured to be suitable for its intended purpose. Suitable mats for different purposes may be rigid or have some flexibility The strength of the mat may be varied for different purposes. Without limiting the generality of the foregoing, the mats may be used to form oilfield or rig matting, construction or worksite matting, temporary roads or driveways, temporary work floors or platforms, stages, walkways (with or without railings), bridges or docks built on a substructure, floating structures such as bridges or docks, temporary shelters or barriers, furniture such as bookshelves, cabinets, tables or dividers, shoring, spill containment or secondary containment structures, or trench barriers.

The mat may be monolithic or assembled from components, and may have closed or open major surfaces. A mat may be made from a frame with cross-members and planking, as is commonly used in rig mats. The components of the mat may be formed from metal, wood, plastic, composite materials, or other suitable material, as is known in the art.

As used herein, reference to the shape of the mat is that shape shown in a top plan view. The length and width of the mat may be linear dimensions along edges of the shape, or parallel to an edge. The height of the mat is the dimension between the opposing major surfaces. An edge surface is that which exists between the opposing major surfaces, along an edge of the mat.

As used herein, the term “vertical” shall refer to a direction perpendicular to the major surfaces, while the term “horizontal” shall refer to a direction parallel to the major surfaces, as if the mat is lying flat on the ground. These terms may not reflect the actual orientation or direction during assembly or use of the apparatuses described.

In aspects of the invention, each mat or panel abuts an adjacent mat or panel along a first edge, and each mat or panel has a second edge which forms a corner at an intersection with the first edge.

In one embodiment, the mats (1) are quadrilateral in shape, such as squares or rectangles, which are interconnected together in a simple end-to-end and/or side-to-side configuration. In alternative embodiments, the mats may have different geometric shapes, allowing for different interconnecting patterns.

The mats or panels may be connected together by a cable system or an expanding plug system, or both systems, as described in further detail below.

In some embodiments, a cable system is conveniently described in reference to a four-corner junction, as shown in FIG. 3. Each corner of each mat has a vertical opening (10), which is preferably cylindrical, as well as edge or side openings (12) in each edge surface adjacent the corner. The side openings connect with the vertical opening to create a channel through the corner. The vertical opening (10) may be lined with a sleeve (11) which defines openings aligned with the edge or side openings (12). When two mats are abutted together with their corners aligned, the side openings (12) are aligned, as shown in FIG. 3. In some embodiments, an alignment sleeve (14) may be provided which inserts into aligned side openings (12). The alignment sleeve may carry a washer, such as a foam rubber washer, to help seal the openings against water and/or debris ingress.

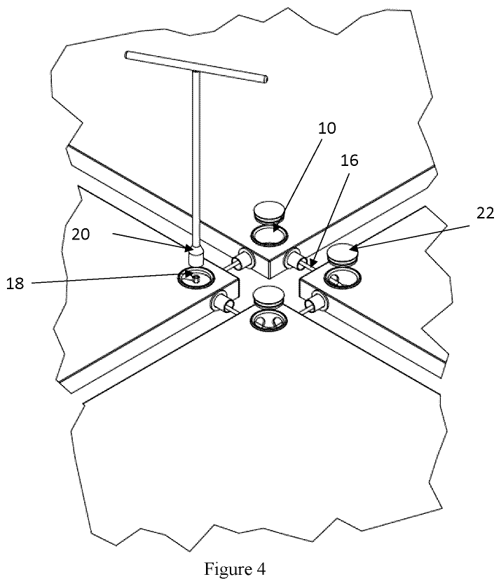

A cable (16) is inserted and passed through the side openings (12) and alignment sleeves (14), so as to pass through each of the four corners, as shown in FIG. 4. One end of the cable is secured in an opening using a fastener or other suitable means, while the other end of the cable is attached to and wound onto a drum (18). Alternatively, both ends of the cable may be attached to the drum. Winding the cable onto the drum shortens the effective length of the cable and tightens the cable, drawing all four corners closer together. The drum preferably comprises ratcheting pawls, and a drive bolt which can be turned with, for example, a standard socket (20) or wrench. Cover caps (22) with O-ring seals may be provided to close the vertical openings.

In other embodiments, the cable (16) may be used through channels that are disposed on or through edges of adjacent mats, not in the mat corners. The channels are U-shaped as both ends of the channel open into the same edge surface.

The cable system may be particularly suitable where adjacent mats may not be co-planar, such as if the mats are lying on uneven terrain, as some limited angles between adjacent mats may be tolerated.

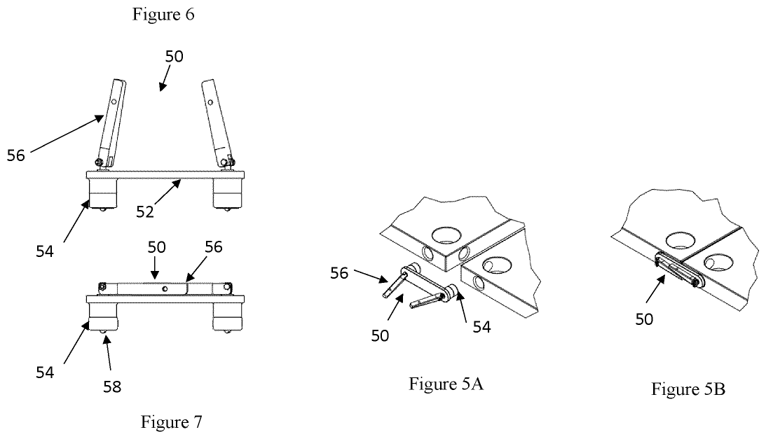

In some embodiments, an expanding plug system comprises a bridge connector (50) which comprises a connector body (52) having at least two expanding plugs (54) disposed on opposing ends of the connector. The plugs (54) are configured to be inserted into openings on adjacent mats with a relatively snug fit, and to expand radially outwards upon axial compression. Upon expansion, the plugs securely engage the opening, to connect the adjacent mats together, as shown in FIGS. 5A and 5B. The plugs preferably have a high coefficient of friction with the mat material, so as to securely engage the mat when installed. Alternatively, the inner surface of the openings may be textured or have elements which engage the plug. The expanding plug may comprise any suitable material include various resilient elastomers, such as a rubber.

FIG. 6 shows one embodiment of a expanding plug connector, having two expanding plugs disposed on opposing ends of an elongate connector body (52). Each expanding plug (54) is activated by a lever (56) and cam configuration, where the lever (56) and cam act on a pin (58) which axially compresses an elastomer plug (54). Upon compression, the elastomer plug bulges radially outwards and thus grips the inside surface of an opening. The levers lie flat as shown in FIG. 7 when the plugs are in a compressed position. This configuration may be used to connect side openings, as seen in FIG. 5B, and may also be used to connect vertical openings, however, may not be preferred for use on the major surfaces because of a trip hazard created.

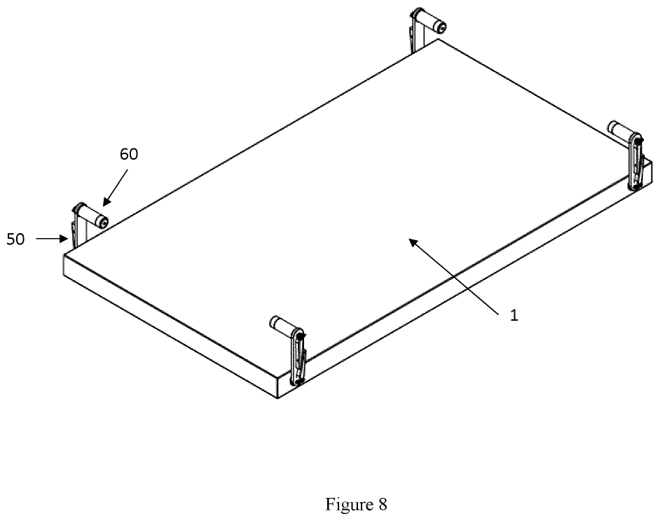

A modified version of an expanding plug connector (50) is shown in FIG. 8, which are installed in a mat (1) to create carrying handles (60). In this embodiment, one expanding plug (54) is inserted into a side opening and the connector is oriented upwards, and the opposing end is configured as a handle (60). Thus, a convenient structure to grasp and carry the mat (1) is created. In some embodiments, the opposing end may be configured, instead of a handle, with a clevis, sling, or opening to facilitate the use of lifting and positioning equipment.

In some embodiments, an expanding plug connector may be used to attach hardware to a mat, such as cleats, studs, sockets, cable anchors, conduit and pipe clamps, cable trays and the like. The opening to which the expanding plug connector can be positioned in any location on the mat surface so that customizable positions can be produced. A hole may be drilled at any location and a sleeve can be bonded or mechanically connected into the mat (1).

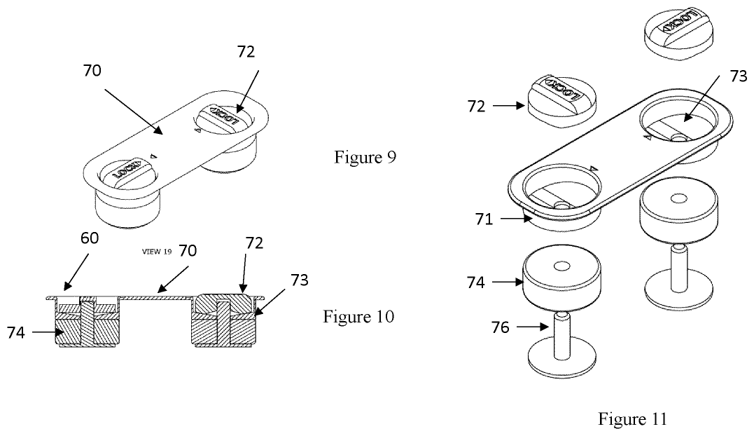

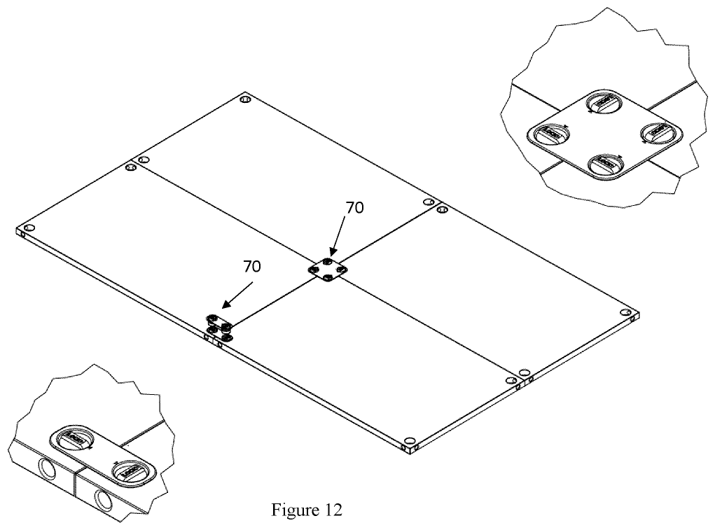

An alternative embodiment of an expanding plug connector (70) is shown in FIG. 9, where a rotating cam (72) is used to compress and expand the expanding plug (74), instead of a lever/cam/pin arrangement. The underside of the rotating cam defines lobes which act on a disc (73) having angled surfaces to compress the plugs, which expand radially. The connector (70) comprises a flat member and a plurality of wells (71) which are configured to insert into a mat opening. The configuration may permit the rotating cam to lock into a compressed position by a ¼ turn. Alternatively, a nut may be simply threaded onto a shaft (76) and rotated to compress the elastomeric plug and expand it radially outward.

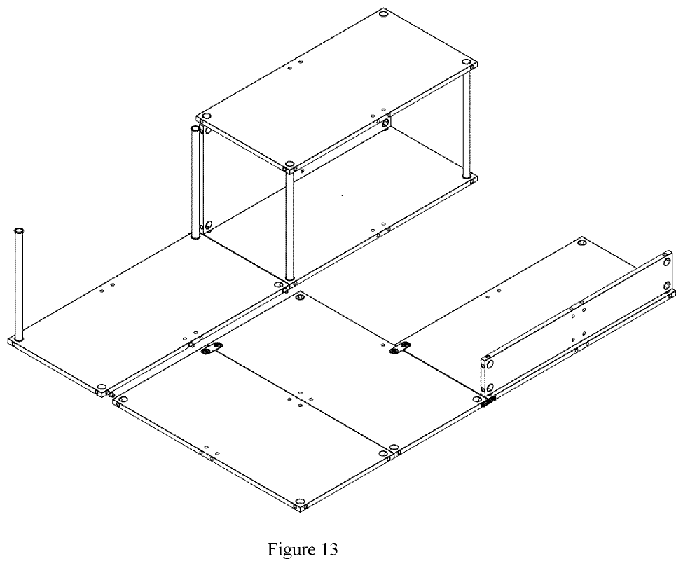

As shown in the Figures, a rotating cam expanding plug configuration of connector may be used to connect two adjacent panels using side openings. However, because the connector has a relatively low profile (flat), with the rotating cams (72) recessed into the wells (71), it may be used in vertical openings on a major surface to connect two or more mats together, as shown in FIG. 12, without creating a trip hazard. The interconnected vertical openings may be positioned at any position along the mat edge, not necessarily limited to the mat corners.

Where an expanding plug connector (70) is used to interconnect 4 mats, as is shown in FIG. 12, the connector body may comprise a square or rectangular shape, with expanding plugs at each corner. Alternatively, the connector body may comprise 4 arms, such as in an X-shape.

The different connectors described herein, and their variants may be used in different combinations to create 2-dimensional mat arrays, and 3-dimensional structures, as is shown in FIG. 13.

### Exemplary Aspects

In view of the described devices, systems, and methods and variations thereof, certain more particularly described aspects of the invention are presented below. These particularly recited aspects should not however be interpreted to have any limiting effect on any different claims containing different or more general teachings described herein, or that the “particular” aspects are somehow limited in some way other than the inherent meanings of the language literally used therein.

Aspect 1. An assembly of at least two mats or panels, which abut each along a first edge, and each mat or panel has a second edge which forms a corner at an intersection with the first edge, wherein each corner defines a channel between the first edge and the second edge, and the assembly comprises:
(a) a cable passing through the corner channel of each of abutting mat or panel, wherein each end of the cable is secured; and
(b) a ratchet or winch mechanism for shortening the effective length of the cable;
(c) wherein the cable, when shortened, retains the abutting mats or panels in contact with each other.

Aspect 2. The assembly of aspect 1 wherein each mat or panel has a quadrilateral shape, such as a rectangle having right angle corners.

Aspect 3. The assembly of aspect 1 or 2 wherein the ratchet mechanism may comprise a ratcheting winch drum disposed in an opening in one mat or panel.

Aspect 4. The assembly of aspect 3 wherein the ratcheting drum comprises a drive head or nut which can be turned by a wrench or socket.

Aspect 5. The assembly of any one of aspects 1-4, wherein the assembly comprises four mats or panels with a four-corner junction.

Aspect 6. An assembly of at least two mats or panels having adjacent edge, each mat or panel edge defining an opening either in an edge surface and/or a major surface, and the assembly comprises a bridge connector having at least two expandable plugs, spaced apart on the connector, and each configured to fit within and expand to securely engage an opening.

Aspect 7. The assembly of aspect 6 wherein the expandable plug comprises a compressible elastomer, which expands radially outwards when compressed axially.

Aspect 8. The assembly of aspect 6 or 7 wherein the expandable plugs have a high coefficient of friction with the interior surface of the opening it engages.

Aspect 9. The assembly of any one of aspect 6-8, wherein the expandable plugs may be compressed by a cam operated by a lever, by a rotating cam actuator or by a nut and bolt configuration.

Aspect 10. The assembly of any one of claims 6-9, wherein the openings are adjacent a corner of each mat or panel.

Aspect 11. The assembly of any one of aspects 6-10 comprising at least four mats or panels, and the connector comprises four expandable plugs, configured to connect four mats or panels together in a four-corner junction.

Aspect 12. A two-dimensional mat array or three-dimensional structures formed with mats or panels and connectors described herein.

Aspect 13. A method of connecting a mat or panel to an adjacent mat or panel, by installing a cable system or a bridge connector as described herein into the adjacent mats or panels.

Aspect 14. An assembly of at least two mats or panels, which abut each along a first edge, each mat or panel defining a channel which aligns with a channel of the abutting mat or panel, and the assembly comprises:
(a) a cable passing through the aligned channels, wherein each end of the cable is secured; and
(d) a ratchet or winch mechanism for shortening the effective length of the cable;
(e) wherein the cable, when shortened, retains the abutting mats or panels in contact with each other.

Aspect 15. A kit for forming a two-dimensional or three-dimensional mat array or structure, comprising at least two mats and at least one connector comprising either or both of:
(a) a cable for passing through a channel of each mat, wherein each end of the cable is secured, and a ratchet or winch mechanism for shortening the effective length of the cable: such that, when shortened, the cable retains abutting mats in contact with each other; and/or
(b) a bridge connector having at least two expandable plugs, spaced apart on the connector, and each expandable plug configured to fit within and expand to securely engage an opening in each of the at least two mats

### Interpretation.

The corresponding structures, materials, acts, and equivalents of all means or steps plus function elements in the claims appended to this specification are intended to include any structure, material, or act for performing the function in combination with other claimed elements as specifically claimed.

References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such module, aspect, feature, structure, or characteristic with other embodiments, whether or not explicitly described. In other words, any module, element or feature may be combined with any other element or feature in different embodiments, unless there is an obvious or inherent incompatibility, or it is specifically excluded.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The singular forms “a,” “an,” and “the” include the plural reference unless the context clearly dictates otherwise. The term “and/or” means any one of the items, any combination of the items, or all of the items with which this term is associated. The phrase “one or more” is readily understood by one of skill in the art, particularly when read in context of its usage.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio.

1. An assembly of at least two mats or panels, which abut each along a first edge, and each mat or panel has a second edge which forms a corner at an intersection with the first edge, wherein each corner defines a channel between the first edge and the second edge, and the assembly comprises:
a) a cable passing through the corner channel of each of abutting mat or panel, wherein each end of the cable is secured; and
b) a ratchet or winch mechanism for shortening the effective length of the cable;
c) wherein the cable, when shortened, retains the abutting mats or panels in contact with each other.

2. The assembly of claim 1 wherein each mat or panel has a quadrilateral shape.

3. The assembly of claim 1 wherein the ratchet mechanism may comprise a ratcheting winch drum disposed in an opening in one mat or panel.

4. The assembly of claim 3 wherein the ratcheting drum comprises a drive head or nut which can be turned by a wrench or socket.

5. The assembly of claim 1, wherein the assembly comprises four mats or panels with a four-corner junction.

6. An assembly of at least two mats or panels having adjacent edges, each mat or panel edge defining an opening either in an edge surface and/or a major surface, and the assembly comprises a bridge connector having at least two expandable plugs, spaced apart on the connector, and each configured to fit within and expand to securely engage an opening.

7. The assembly of claim 6 wherein the expandable plug comprises a compressible element which expands radially outwards when compressed axially.

8. The assembly of claim 6 wherein the expanded plugs securely engage the interior surface of the opening it is inserted into.

9. The assembly of claim 6, wherein the expandable plugs may be compressed by a cam operated by a lever, by a rotating cam actuator or by a nut and bolt configuration.

10. The assembly of claim 6, wherein the openings are adjacent a corner of each mat or panel.

11. The assembly of claim 6 comprising at least four mats or panels, and the connector comprises four expandable plugs, configured to connect four mats or panels together in a four-corner junction.

12. A two-dimensional mat array or a three-dimensional structure formed with mats and connectors comprising:
a) a cable for passing through a corner channel of each of a mat, wherein each end of the cable is secured, and a ratchet or winch mechanism for shortening the effective length of the cable; such that, when shortened, the cable retains abutting mats in contact with each other; and/or
b) a bridge connector having at least two expandable plugs, spaced apart on the connector, and each configured to fit within and expand to securely engage an opening in each of the at least two mats.

13. An assembly of at least two mats or panels, which abut each along a first edge, each mat or panel defining a channel which aligns with a channel of the abutting mat or panel, and the assembly comprises:
a) a cable passing through the aligned channels, wherein each end of the cable is secured; and
b) a ratchet or winch mechanism for shortening the effective length of the cable;
c) wherein the cable, when shortened, retains the abutting mats or panels in contact with each other.

14. The assembly of claim 13, wherein the channels are disposed in a corner of each mat or panel, or along an edge of each mat or panel.

15. (canceled)
